(19) United States
(12) Patent Application Publication
(10) Pub. No.: US 2009/0094645 A1
(43) Pub. Date: Apr. 9, 2009

(54) METHOD OF CONTROLLING REMOTE-CONTROLLED ELECTRONIC DEVICE USING UNIVERSAL REMOTE CONTROLLER AND UNIVERSAL REMOTE CONTROLLER THEREOF

(76) Inventors: Yi-Liang Ting, Taipei City (TW); Ssu-Cheng Chan, Taipei City (TW)

Correspondence Address: BIRCH STEWART KOLASCH & BIRCH, PO BOX 747, FALLS CHURCH, VA, 22040-0747, US

(21) Appl. No.: 12/271,756

(22) Filed: Nov. 14, 2008

Related U.S. Application Data
(63) Continuation-in-part of application No. 11/159,358, filed on Jun. 23, 2005.

(30) Foreign Application Priority Data
Jun. 28, 2006 (TW) 093118754

(51) Int. Cl. G06F 13/00; H04N 5/44; H04N 7/173

(52) U.S. Cl. 725/39; 348/734; 725/110; 348/E05.096

(57) ABSTRACT

A method of controlling a remote-controlled electronic device using a universal remote controller comprises the following steps. The first step is to provide a universal remote controller. The second step is to establish a communication link between the universal remote controller and a first electronic device, such that the universal remote controller is able to obtain a playback list from the first electronic device through the communication link and the first electronic device is able to obtain a user related information from the first electronic device through the communication link. The third step is that the universal remote controller classifies the playback list. The fifth step is that the universal remote controller receives execution commands from an input device based on the classified playback list, and the universal remote controller transmitting wireless signal commands corresponding to the execution commands to a second electronic device based on the execution commands.

This application is a Continuation-In-Part of U.S. patent application, Ser. No. 11/159,358, filed Jun. 23, 2005.

### BACKGROUND OF THE INVENTION

1. Field of the Invention

This invention relates to a method of controlling a remote-controlled electronic device and remote controller thereof particularly to a method of controlling a remote-controlled electronic device and remote controller thereof that is able to update, classify and organize information, such as TV program broadcasting schedule, at any time, to provide users with sufficient information for remotely controlling entries to be remotely controlled.

2. Background of the Invention

Conventional remote controllers for use with home appliances are mostly categorized into two categories. The first is the so-called independent remote controllers that are only capable of controlling a designated home appliance for its remote control operation. Such a category of remote controller carries out all remote control functions by individual pushbuttons. The user remotely controls the home appliance through the selected pushbuttons. The second is the so-called multi-functional remote controllers, which are capable of remotely controlling more than one home appliance. Such remote controllers configure the remote control command codes of all home appliances within its interior electronic circuits. However, the interface provided by these two categories of conventional remote controllers is plural pushbuttons. That is, the conventional remote controllers are designed to replace the operations performed by pushing the pushbuttons provided on the home appliances. Thus, the conventional remote controllers are inherently incapable of providing the user with sufficient information, such as the programs title that is currently broadcasted by an X channel.

In view of the drawbacks of the conventional remote controllers, disclosed is a method of controlling remote-controlled electronic device and remote controller thereof that is able to update, classify and organize information, such as TV program broadcasting schedules, at any time, to provide users with sufficient information for remotely controlling entries to be remotely controlled.

### SUMMARY OF THE INVENTION

It is a first object of this invention to provide a method of controlling a remote-controlled electronic device, where entries to be remotely controlled may be updated at any time using the universal remote controller of this invention, such as the most updated TV program broadcasting schedule, given sufficient information, so as to allow the user to remotely control the electronic device.

It is another object of this invention to provide a universal remote controller capable of downloading entries to be remotely controlled at any time, such as the most updated TV program broadcasting schedule, and then classifying and organizing the information, to allow the user to remotely control the electronic device in an easy manner.

To achieve the above objects this invention provides a method of controlling a remote-controlled electronic device using a universal remote controller, comprising the steps of: providing a universal remote controller; establishing a communication link between the universal remote controller and a first electronic device, such that the universal remote controller is able to obtain a playback list from the first electronic device through the communication link, wherein the playback list includes at least one broadcasting entry; the universal remote controller classifying the playback list based on attributes of individual broadcasting entries; the universal remote controller receiving execution commands from an input device based on the classified playback list, and the universal remote controller transmitting wireless signal commands corresponding to the execution commands to a second electronic device based on the execution commands.

This invention further discloses a universal remote controller based on the spirit of the above method of controlling.

### BRIEF DESCRIPTION OF THE DRAWINGS

These and other modifications and advantages will become even more apparent from the following detained description of a preferred embodiment of the invention and from the drawings in which:

FIG. 1 is a flowchart illustrating a method of this invention;

FIG. 2 is a schematic drawing illustrating a universal remote controller according to a first embodiment of this invention;

FIG. 3 is a schematic drawing illustrating a playback list obtained from a first electronic device according to this invention;

FIG. 4 is a diagram illustrating the information structure of the TV program broadcasting schedule of the playback list obtained from the first electronic device;

FIG. 5 is a diagram illustrating the information structure of the MP3 soundtrack summary table of the playback list obtained from the first electronic device;

FIG. 6 is a schematic drawing illustrating the appearance of the universal remote controller of this invention;

FIG. 7 is diagram illustrating the information structure of the command concordance table for use with a second electronic device:

FIG. 8a is a schematic drawing illustrating a universal remote controller according to a second embodiment of this invention;

FIG. 8b is a schematic drawing illustrating a second electronic device of FIG. 2;

FIG. 9a is a schematic drawing illustrating an arrangement of a universal remote controller, a first electronic device, a second electronic device, and a internet-connected device according to a method of this invention;

FIG. 9b is a schematic drawing illustrating an arrangement of a universal remote controller, a first electronic device, a second electronic device, and a internet-connected device according to a method of this invention;

FIG. 10 is a schematic drawing illustrating an arrangement of a universal remote controller, a first electronic device, and three second electronic devices according to a method of this invention;

FIG. 11 is a schematic drawing illustrating an arrangement of a universal remote controller, a first electronic device, a second electronic device, and a internet-connected device according to a method of this invention;

FIG. 12 is a schematic drawing illustrating an arrangement of a universal remote controller, a first electronic device, and a second electronic device according to a method of this invention.

### DETAILED DESCRIPTION OF THE INVENTION

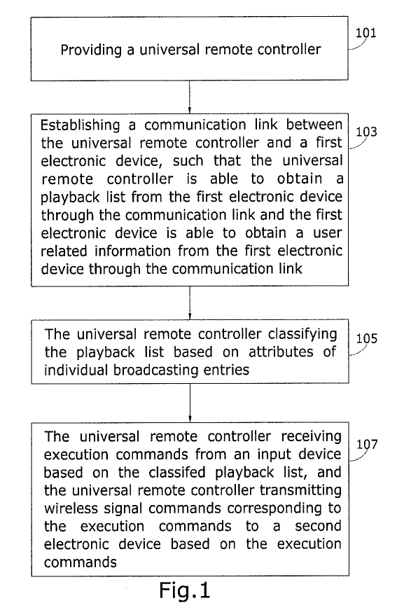

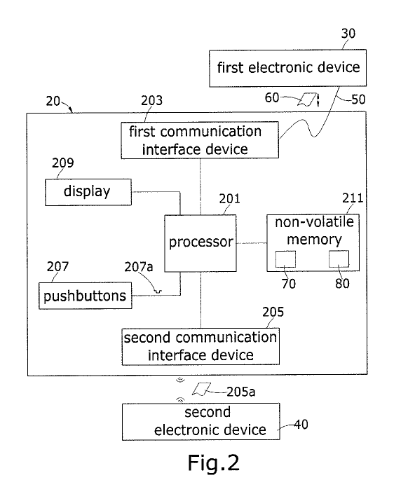

FIG. 1 is a flowchart illustrating a method of this invention and FIG. 2 is a schematic drawing illustrating a universal remote controller of this invention. According to this invention, the method of controlling a remote-controlled electronic device using a universal remote controller 20 comprises the following steps described in detail as follows. Step (101) provides a universal remote controller 20, details of the universal remote controller 20 will be described later. Step (103) establishes a communication link 50 between the universal remote controller 20 and a first electronic device 30, such that the universal remote controller 20 is able to obtain a playback list 60 from the first electronic device 30 through the communication link 50 and the first electronic device 30 is able to obtain a user related information (not shown) from the first electronic device 30 through the communication link 50, wherein the playback list 60 includes at least one broadcasting entry 601, and the communication link 50 can be a bidirectional communication link but not limited to that described in this embodiment. The user related information can be such as user behavior patterns, evaluation, environment information, location information, recommendation from users and so on. In Step (103), the actual implementation of the communication link 50 may include a wired communication link, a wireless communication link, WAN or LAN, where a corresponding electronic circuit is implemented to the universal remote controller 20 based on the measure of the communication link 50 as selected. For example, the communication link 50 may be a USB interface that connects the universal remote controller 20 to the first electronic device 30 through a USB cable. The electronic device 30 provides a playback list 60 to be downloaded by the universal remote controller 20 through the communication link 50.

In Step (105), the universal remote controller 20 classifies the playback list 60 based on attributes of individual broadcasting entries 601. The playback list 60 obtained in Step (103) may be inclusive of everything. For example, the playback list 60 may be the TV program broadcasting schedule provided by a cable service provider, a Karaoke soundtrack summary table to be used in a Karaoke player, an MP3 soundtrack summary table of all CD/MP3 soundtracks stored in a computer, file names of individual CD/MP3 soundtracks, a DVD movie title summary table of all DVD movie titles stored in a computer, file names of individual DVD movie titles, a VCD movie title summary table of all VCD movie titles stored in a computer, or file names of individual VCD movie titles. Such playback lists 60 must be classified by the universal remote controller 20 based on attributes of the individual broadcasting entries 601, where the broadcasting entry 601 of the same or similar attributes are classified into the same classification. For example, in the TV program broadcasting schedule provided by an XX cable service provider, the TV programs may be classified into different classifications based on the orientation of the programs into Western movie titles, Oriental Movies, Finance and Economics programs or News programs.

Furthermore, in the classifying step of Step (105), this step is able to perform classification based on the company titles of different cable service providers. Since the TV program broadcasting schedules vary among different cable service providers, the universal remote controller 20 of this invention is able to display the company title of the respective cable service provider on its display 209. The user may then select the desired cable service provider. By means of the selection of the cable service provider by the user, the universal remote controller 20 is able to precisely select the TV program broadcasting schedule of the described cable service provider, and then classify the programs to be broadcasted in each channel into different classifications based on the orientation of the programs into Western movie titles, Oriental Movies, Finance and Economics programs or News programs.

In Step (107), the universal remote controller 20 receives execution commands from an input device based on the classified playback list 70, and the universal remote controller transmitting wireless signal commands 205a corresponding to the execution commands to a second electronic device 40 based on the execution commands. In Step (107), the actual implementation of the input device may include plural pushbuttons 207 ( at least one input device) provided on the universal remote controller 20, or even a touch screen as the input device. Execution commands are generated upon pressing these pushbuttons 207 for manipulating the playback list 70, such as switching to the TV program broadcasted by a certain channel in the playback list 70, or configuring the schedule for recording a TV program broadcasted by a certain channel in the playback list 70 in real-time or advanced, or playing back a certain DVD movie title, a certain VCD movie title, or a certain soundtrack on an audio-CD disc, or the entire CD disc, or a certain MP3 on an MP3 disc, or the entire MP3 disc. Then, the universal remote controller 20 transmits wireless signal commands 205a corresponding to the execution commands to a second electronic device 40 based on the execution commands. Accordingly, after receiving the signal commands 205a, the second electronic device 40 would automatically initiate the above recording or playback operations.

The actual implementation of the first electronic device 30 of this invention may include a computer, a remote server, or a remote web site. The actual implementation of the second electronic device 40 may include a DVD/VCD/CD/MP3 player, a TV set, an audio appliance, a computer, a Karaoke player, and a set-top-box. Alternatively, the first electronic device 30 and the second electronic device 40 in this invention may be independent electronic devices, or of a single electronic device.

In FIG. 2, individual elements of the universal remote controller 20 according to a first embodiment of this invention are described as follows. A first communication interface device 203 serves to communicate with the first electronic device 30. The above communication link 50 is established by the first communication interface device 203 and first electronic device 30. A second communication interface device 205 serves to communication with the second electronic device 40. The above wireless signal commands 205a are transmitted to the second electronic device 40 through the second communication interface device 205. The actual implementation of the second communication interface device 205 may include an infrared wireless transmission circuit. The plural pushbuttons 207 serve to generate the pushbutton signal 207a. The execution command is realized by pushing the pushbuttons 207. The display 209 serves to display the operation screen (for example, touch screen) of the universal remote controller 20, through which operation screen the user is able to clearly learn the current operation status or to input entries to the execution commands following the instructions provided by the operation screen. A non-volatile memory 211 is electrically connected to a processor 201, and stores the classified playback list 70. The actual implementation of the non-volatile memory 211 may include flash memory.

In FIG. 2, the processor 201 is electrically connected to the first communication interface device 203, the second communication interface device 205, plural pushbuttons 207, display 209 and non-volatile memory 211. The processor 201 serves the following functions. The processor 201 serves to obtain the playback list 60 from the first electronic device 30 through the first communication interface device 203, wherein the playback list 60 includes at least one broadcasting entry 601. The processor 201 then classifies the playback list 60 based on attributes of individual broadcasting entries 601 and stores the classified playback list 70 to the non-volatile memory 211. The processor 201 then receives the pushbutton signals 207a, wherein the pushbutton signals 207a serve as execution commands of the classified playback list 70. The processor 201 then transmits wireless signal commands 205a corresponding to the pushbutton signals 207a to the second electronic device 40 based on the pushbutton signals 207a through the second communication interface device 205.

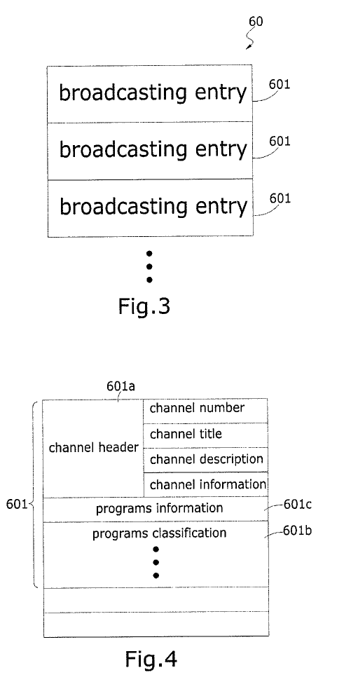

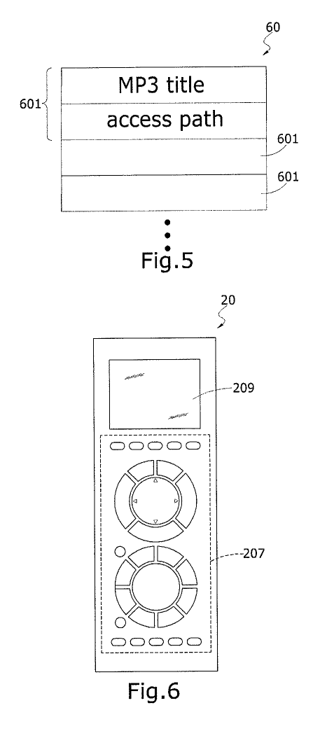

FIG. 3 is a schematic drawing illustrating a playback list obtained from a first electronic device according to this invention. FIG. 4 is a diagram illustrating the information structure of the TV program broadcasting schedule of the playback list obtained from the first electronic device. FIG. 5 is a diagram illustrating the information structure of the MP3 soundtrack summary table of the playback list obtained from the first electronic device. In FIG. 3, the playback list 60 includes plural broadcasting entries 601. The context of each broadcasting entry 601 differs due to the different variety of the playback list 60. In FIG. 4, each broadcasting entry 601 of the TV program broadcasting schedule 60 includes a channel header 601 a, plural program informations 601b, and program classification 601c, wherein the channel header 601a includes a channel number, a channel title, a channel description, and channel information. The program information 601b memorizes the programs titles, starting time and ending time of all TV programs of the channel number. In FIG. 5, each broadcasting entry 601 of the MP3 soundtrack summary table 60 includes the title of and path for accessing each MP3 soundtrack, wherein the accessing path is mainly provided to the second electronic device 40, such that the second electronic device 40 is able to learn where to access the desired MP3 soundtrack.

FIG. 6 is a schematic drawing illustrating the appearance of the universal remote controller of this invention. In FIG. 6, the plural pushbuttons 207 are provided to the universal remote controller 20. Furthermore, based on the programs that have been classified into different classifications based on the orientation of the programs into Western movie titles, Oriental Movies, Finance and Economics programs or News programs, the user is able to quickly select one of the programs classified into this category by selecting the pushbutton 207 labeled as “Western,” “Oriental,” “Finance and Economics,” or “News.”

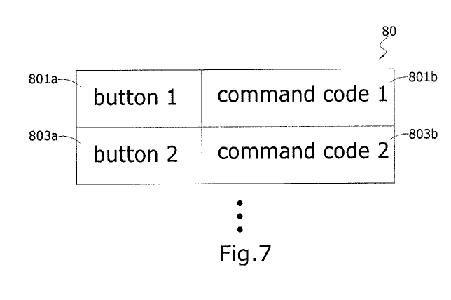

The number of playback lists 70 stored in the non-volatile memory 211 of this invention is not limited to one, such that the universal remote controller 20 is able to remotely control more than one second electronic device 40. Furthermore, the non-volatile memory 211 may store more than one command concordance table 80, where different command concordance tables 80 are adapted to second electronic devices 40 different brands or models. FIG. 7 is diagram illustrating the information structure of the command concordance table for use with a second electronic device. In FIG. 7, the plural pushbuttons 207 sequentially correspond to Field 801a, Field 803a . . . and the corresponding command codes are defined in Field 801b, Field 803b . . . , respectively. Accordingly, upon receiving the pushbutton signal 207a generated by the pushbuttons 207, the processor 201 would transmit wireless signal commands 205a corresponding to the second electronic device 40 to be remotely controlled through the second communication interface device 205 based on the command codes defined in the command concordance table 80.

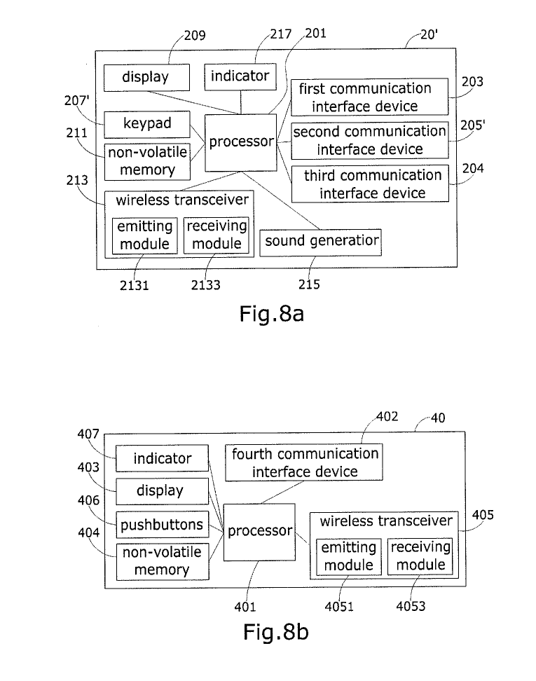

FIG. 8a is a schematic drawing illustrating a universal remote controller according to a second embodiment of this invention. As shown in FIG. 8a, a universal remote controller 20′ according to a second embodiment of this invention comprises a processor 201, a first communication interface device 203, a second communication interface device 205′, a third communication interface device 204, a keypad 207′, a display 209, a non-volatile memory 211, a wireless transceiver 213, a sound generator 215, and a indicator 217. The use of the same or similar reference number throughout the several embodiments designates a like or similar element.

In the second embodiment, the third communication interface device 204 serves to communicate with a third first electronic device (not shown). The keypad 207′ can be a physical keypad or a virtual keypad. The display 209 may be a self-charge display. The wireless transceiver 213 comprises an emitting module 2131 and a receiving module 2133 for bidirectional communication link, wherein the emitting module 2131 can be an infrared emitter and the receiving module 2133 can be, but not limited to, an infrared receiving module. The sound generator 215 may be a speaking device or a voice device. The indicator 217 may be an indication LED.

FIG. 8b is a schematic drawing illustrating a second electronic device 40 of FIG. 2. As shown in FIG. 8b, the second electronic device 40 comprises but not limited to a processor 401, a fourth communication interface device 402, a display 403, a non-volatile memory 404, a wireless transceiver 405, a plurality of pushbuttons 406, and a indicator 407.

The processor 401 serves to obtain the above-mentioned user related information from the first electronic device 30 through the communication link 50. The fourth communication interface device 402 serves to communicate with an internet-connected device (not shown). The display 403 serves to display such as program broadcasting schedules following the instructions provided by the universal remote controller 20 or 20′. The wireless transceiver 405 comprises an emitting module 4051 and a receiving module 4053 for bidirectional communication link, wherein the emitting module 4051 can be an infrared emitter and the receiving module 4053 can be, but not limited to, an infrared receiver. The indicator 407 may be an indication LED.

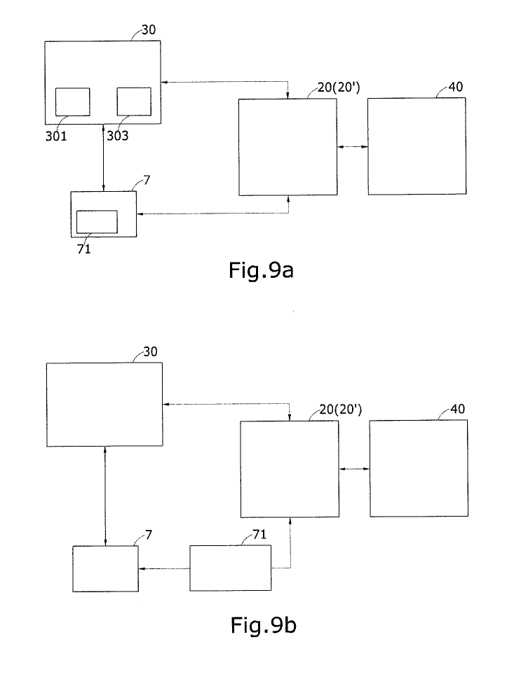

FIG. 9a is a schematic drawing illustrating an arrangement of a universal remote controller 20 (20′), a first electronic device 30, a second electronic device 40, and an internet-connected device 7 according to a method of this invention. As shown in FIG. 9a, the universal remote controller 20 (20′) is electrically connected to the first electronic device 30 and the internet-connected device 7, and the first electronic device 30 and the internet-connected device 7 are electrically connected to each other, wherein the internet-connected device 7 includes a bidirectional communication link 71 such as USB dongle. That is, the universal remote controller 20 (20′) is communicating with the first electronic device 30 through the internet-connected device 7 and is communicating with at least one second electronic device 40 through a bidirectional communication link.

In some embodiments, a method of controlling a remote-controlled electronic device using the universal remote controller, comprises the steps of: establishing a bidirectional communication link between the universal remote controller and the first electronic device through the internet-connected device; providing a first information to the first electronic device directly and/or providing a second information to the first electronic device from the universal remote controller through the internet-connected device; and providing a using/enabling status of the first electronic device based on the first information and the second information, such that the universal remote controller generates an information corresponding to the using/enabling status so as to update and display the first information and the second information in real-time.

The universal remote controller of the invention further comprises a step of setting relevant conditions on the universal remote controller, and sending the set conditions (the first information and the second information) to the internet-connected device, wherein the internet-connected device is connected to the internet and operates on the network in compliance with the conditions, and the internet-connected device stores all records about operations on the internet for making a query, or directly sends the records back to the universal remote controller or the first electronic device.

It should be noted that, the internet-connected device 7 may be provided with software (not shown). The software is used for internet-connection management, which monitors all internet-connection operations and time, and uses the communication link 71 (for example, a dongle) to download data (for example, a playback list number, channel title, channel description, channel information, programs information, programs classification, and so on) from the first electronic device 30 (for example, a server) and then to upload the data to the second electronic device 40 (for example, a TV). In this embodiment, the dongle is used as the communication link 71. However, in other embodiments, the communication link 71 may also be another gatekeeper that provides a channel for signal transmission or another equivalent element. Meanwhile, when the pushbuttons 207, the keypad 207′, or the pushbuttons 406 include phone keys or a keypad, in the case that it intends to make a phone call through the universal remote controller 20 (20′), the universal remote controller 20 (20′) connects the internet through the internet-connected device 7 to make an IP-based voice communication/call, that is, VoIP wireless communication/call. In this embodiment, a full-duplex transmission is provided between the internet-connected device 7 and the universal remote controller 20 (20′).

The first electronic device 30 is built in with a database 301, which stores, for example, channel category data, program category data (including categories and sub-categories), a program list in a certain period in the future (for example, seven days), program bonuses, shopping information, and cue lists. An RF module 303 may be disposed in the first electronic device 30 and used to perform wireless communication with the communication link 71. The second electronic device 40 such as a TV receives signals emitted by an emitter 2133 of the universal remote controller 20 (20′).

In this embodiment, first, establishes a first bidirectional communication link (the internet-connected device 7) between the universal remote controller 20′ and the first electronic device 30, and establishes a second bidirectional communication link between the universal remote controller 20′ and the second electronic device 40; then, provides information(s) to the universal remote controller 20′ from the first electronic device through the internet-connected device 7; and provide a second information to the first electronic device 30 from the first electronic device 40 through the second bidirectional communication link.

For example, the universal remote controller 20 (20′), the first electronic device 30, and the second electronic device 40 carry out bidirectional wireless communication among one another. The universal remote controller 20 (20′) may retrieve data from the first electronic device 30 through the internet-connected device 7, or directly retrieve data from the first electronic device 30. The internet-connected device 7 may be a computer, a game console, a media player, or another equivalent device that may be connected to a wireless network. The first electronic device 30 may be a server storing a categorized database. The categorized database may be of various types such as original, sorted, classified, valued, or marked, and includes, but not limited to, a TV, AM/FM radio, EPG, or music song database. The second electronic device 40 may be an entertainment device (such as a TV, AM/FM radio, EPG-integrated multimedia device, or media player), or a detection & control device (such as home-automation client device).

In the method of controlling a remote-controlled electronic device using the universal remote controller 20 (20′), the user may first set relevant conditions including (but not limited to) the internet-connection time, internet-connection condition, internet-connection object, setting cancellation (that is, the first information and the second information), and resetting on the universal remote controller 20 (20′), and send these conditions to the internet-connected device 7, so that the internet-connected device 7 is connected to the internet and operates on the internet in compliance with these conditions. Then, in the next step, the bidirectional communication link (the internet-connected device 7 in this embodiment) provides the using/enabling status of the first electronic device 30 (of course, the above-mentioned information can be transmitted to the first electronic device 30 through the universal remote controller 20 (20′)), so that the universal remote controller 20 (20′) generates an information corresponding to the using/enabling status. For example, the internet-connected device 7 stores all the records about operations on the internet for making a query, or directly sends the records back to the universal remote controller 20 (20′) or the first electronic device 30.

The universal remote controller 20 (20′) detects the using/enabling status of the internet-connected device 7, or the internet-connected device 7 actively informs the universal remote controller 20 (20′) about the using/enabling status of the internet-connected device 7, and meanwhile, the universal remote controller 20 (20′) sends various information and commands to the internet-connected device 7. The corresponding relations between the universal remote controller 20 (20′) and the internet-connected device 7 may be one-to-one, one-to-many, many-to-one, or many-to-many. Thus, the using/enabling status of the first electronic device 30 may be provided through the bidirectional communication link, such that the universal remote controller 20 (20′) generates the information corresponding to the using/enabling status, thereby achieving the internet operation management, and providing a parental control function.

The internet-connected device 7 stores the information and commands obtained through detection, calculation, comparison, sorting, filtering, monitoring, combination, and determination in a built-in memory (not shown), or sends the information and commands to the universal remote controller 20 (20′). The information and commands may be settings or instructions in terms of time, grade or level, control, alarm, storage, recommendation, accusation, selection, limitation, and suggestion. Here, the above detection step may include detecting an internet-connection status of the internet-connected device 7, and the above calculation, comparison, sorting, filtering, monitoring, combination, and determination steps may include calculating, comparing, sorting, filtering, monitoring, combining, and determining the operations of the internet-connected device 7 after the device has been connected to the internet.

FIG. 9b is a schematic drawing illustrating an arrangement of a universal remote controller 20 (20′), a first electronic device 30, a second electronic device 40, and an internet-connected device 7 according to a method of this invention. Comparing FIG. 9b with FIG. 9a, it is found that the communication link 71 of FIG. 9a is disposed in the internet-connected device 7, but the communication link 71 of FIG. 9b is externally connected to the internet-connected device 7. In other words, the internet-connected device 7 and the communication link 71 are two independent devices. Moreover, the similarity between FIG. 9b and FIG. 9a lies in the wireless technologies adopted between the internet-connected device 7 and the first electronic device 30, which may be, but not limited to, Wi-Fi (IEEE 802.11), WiMAX, Mobile Net, or another equivalent wireless technology.

The universal remote controller 20 (20′) may use at least one of the first communication interface device 203, the second communication interface device 205 (205′), or the third communication interface device 204 to detect the using/enabling status of the second electronic device 40, or the second electronic device 40 may actively inform the using/enabling status thereof to the universal remote controller 20 (20′) through the fourth communication interface device 402. Meanwhile, the universal remote controller 20 (20′) may send various information and commands to the second electronic device 40. The second electronic device 40 stores the information obtained through enabling, calculation, comparison, sorting, filtering, monitoring, combination, and determination in a built-in non-volatile memory 404, or sends the obtained information to the universal remote controller 20 (20′).

Thus, the user may use the universal remote controller 20 (20′) to implement the remote control method of the present invention. For example, in the method of the present invention, the universal remote controller 20 (20′) may be used to limit the time segment and duration for using the second electronic device 40. As for the internet-connected device 7 such as a PC, the internet-connection management through software includes online game, chatting, and web browsing management. For example, it may be limited that, the internet can be connected from 8:00 pm to 10:00 pm only, that is, for two hours at most, and cannot be connected in other time segments. As for the internet-connected device 7 such as a TV, the remote controller cannot control the internet-connected device 7 any more once exceeding the set time segment (for example, cannot switch channels or adjust the volume). As for the above function, the prior art can only disable the remote controller, that is, the prior art is a unidirectional control, whereas the present invention further includes a bidirectional control technique, such that the TV and the remote controller have a bidirectional control function and can receive using messages from each other. In other words, in the present invention, besides disabling the remote controller, the buttons of the TV also fail. Moreover, the method of the present invention can further provide a control setting based on program classification, for example, the viewed programs may be set into different categories as required (for example, Restricted Category, Parental Guidance Category, Protected Category, and General Audiences Category). If the program does not fall in the set category, the universal remote controller 20 (20′) does not send RF signals, but remains at the original channel. The method of the present invention also provides a displaying mechanism based on program classification, in which indicator signals (for example, setting the indicator 217) corresponding to different categories are set on the universal remote controller 20 (20′). When a certain program is selected, a corresponding indicator signal is displayed. Moreover, the method of the present invention further provides a viewing/internet-connection recording mechanism, in which the viewing/internet-connection records are selected on the display 209 of the universal remote controller 20 (20′), and the records include, for example, viewed programs and viewing time, as well as internet-connection records of online game (name), chatting (MSN or other chatting rooms), or web browsing (browsed web pages).

Meanwhile, when the universal remote controller 20 (20′) is connected to the first electronic device 30, the universal remote controller 20 (20′) may adjust/select an intelligent traffic optimization and management mechanism according to a traffic returned by the internet-connected device 7. Thus, the intelligent mechanism is enabled to optimize and manage the bandwidth/traffic in operation. For example, the intelligent mechanism records the previous connection time, and takes this time as a preferred connection time for the next connection. Moreover, the rule about a preferred connection for the next time may be determined by calculating the TD time of the universal remote controller 20 (20′) or by making a response after a fixed time period, which is a default value of the system or is set by the user. Therefore, in the case that the firmware upgrade is not required, the universal remote controller 20 (20′) can adjust, modify, enable, disable, or upgrade various hardware and software functions according to parameters or settings downloaded from the internet-connected device 7. Thus, the intelligent mechanism with updated functions can be used. Compared with the prior art that the remote controller must be repaired or replaced due to an upgrade failure, the present invention does not need a complete update, but downloads specific parameters. That is, the upgrade is performed according to various parameters or settings downloaded from the first electronic device 30 or according to variables of the universal remote controller 20 (20′).

In addition, as shown in FIGS. 9a and 9b, the method of the present invention further provides a viewing management mechanism. For example, the user uses the pushbuttons 207, the keypad 207′, the pushbuttons 406, a touch screen, or another equivalent input device to set relevant conditions including (but not limited to) viewing time, viewing limits, viewing object, setting cancellation, or resetting on the universal remote controller 20 (20′), and sends the conditions to the second electronic device 40, so that the second electronic device 40 operates in compliance with these conditions. The second electronic device 40 stores the records about operations or using status in the processor 201 for making a query, or directly sends the records back to the universal remote controller 20 (20′).

The present invention further provides an interaction mechanism. The second electronic device 40 is, for example, a TV, and when a TV program is broadcasted on the TV, the universal remote controller 20 (20′) displays synchronous or asynchronous interactive messages corresponding to or supplementary with the TV program. Thus, (1) the viewer can understand, preview, or query important messages about the TV program, (2) the viewer can complete a “complete communication activity” (including viewing, causing a purchase intention or need, and purchasing), or (3) the viewer can make comments on the TV program, or can perform the market investigation about other topics.

When the interaction mechanism is applied, the universal remote controller 20 (20′) may be used to order relevant products. That is, the corresponding shopping options are displayed on the display 209. For example, when the program introduces about Manchu Han Feast, the display 209 of the universal remote controller 20 (20′) shows how to order the feast, or enables the user to directly order the feast. Alternatively, when Pizza Hut advertisements are broadcasted, the display of the remote controller shows the contact manner of Pizza Hut, or enables the user to directly order pizzas from Pizza Hut. Meanwhile, the universal remote controller 20 (20′) may also provide relevant information, such as details about cooking materials mentioned in a cooking program, or the time when Chien-Ming Wang will appear on the show. In addition, the universal remote controller 20 (20′) may be used to make comments on the viewed program. The viewer may select relevant comments on the program, such as new, considerate, exaggerative, boring, practical, happy, or sad, displayed on the display 209. This function is applicable to a poll, so as to provide the results to a program producer as a reference for future improvement.

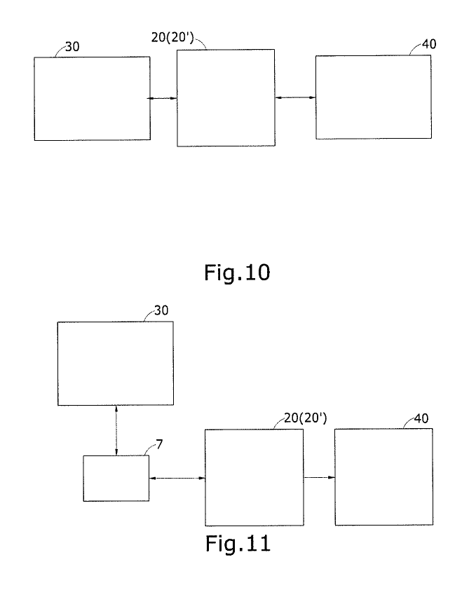

FIG. 10 is a schematic drawing illustrating an arrangement of a universal remote controller 20 (20′), a first electronic device 30, and a second electronic device 40 including three electronic devices according to a method of this invention. As shown in FIG. 10, there are three electronic devices 41, 43, and 45 in the second electronic device 40.

Compared with other embodiments, in this embodiment, the universal remote controller 20 (20′) directly communicates with the first electronic device 30. The electronic device 41 may be entertainment devices (such as TVs and AM/FM radios), the electronic device 43 may be entertainment devices (such as media players), and the electronic device 45 may be detection & control devices (such as home-automation client devices). The specific architecture of the electronic devices 41 and 43 may be as shown in FIG. 8b, but is not limited hereby. In addition, the corresponding relations between the universal remote controller 20 (20′) and the first electronic device 30 may be one-to-one, one-to-many, many-to-one, or many-to-many, but not limited to the implementing aspect of disposing three electronic devices in this embodiment.

Meanwhile, the first electronic device 30 may include a database storing EPG, TV interactive messages, or other categories. The first electronic device 30 stores various information obtained through analyzing, creating, integrating, sorting, valuing, comparison, and classification, which includes (but not limited to) a play list of EPG/music songs/videos and TV interactive messages. The above information is actively or passively sent to the universal remote controller 20 (20′), and the user can operate the universal remote controller 20 (20′) according to the classification preset in the universal remote controller 20 (20′). The information in the universal remote controller 20 (20′) is also actively or passively sent to the first electronic device 30.

Furthermore, when the universal remote controller 20 (20′) is directly connected to the first electronic device 30, the universal remote controller 20 (20′) may adjust/select the intelligent traffic optimization and management mechanism according to the traffic status returned by the first electronic device 30 but without the internet-connected device 7.

Moreover, the universal remote controller 20 (20′) and the electronic devices 41, 43, and 45 maintain a bidirectional wireless interaction there-between. For example, the universal remote controller 20 (20′) instructs one of or a plurality of the electronic devices 41, 43, and 45 to perform a single or combined ON/OFF operation or controlling operation. Alternatively, the information in one of or a plurality of the electronic devices 41, 43, and 45 is read. Alternatively, one of or a plurality of the electronic devices 41, 43, and 45 is instructed to actively send the information to the universal remote controller 20 (20′). Thus, the universal remote controller 20 (20′) can control different devices to meet the requirements of a digital home.

According to different statuses of the device in different time or different stages, the universal remote controller 20 (20′) allows the user to exit a function before the operations of the function are completed, and to directly execute another currently operable function, which greatly improves the usability. Such an easy operation design called Y-Flow enables the user to use the universal remote controller 20 (20′) of the present invention without the assistances of an on-line help and an operation manual. Once a certain key is pressed, other conflicting keys will fail, and after a certain functional key is pressed, functions corresponding to the functional key are executed directly, and thus, the user does not need to exit the current status first.

FIG. 11 is a schematic drawing illustrating an arrangement of a universal remote controller 20 (20′), a first electronic device 30, a second electronic device 40, and an internet-connected device 7 according to a method of this invention.

Compared with other embodiments, in this embodiment, the universal remote controller 20 (20′) is in a unidirectional wireless communication with the second electronic device 40. For example, the using/enabling status of the internet-connected device 7 may be detected, or the internet-connected device 7 actively informs the universal remote controller 20 (20′) about the using/enabling status of the internet-connected device 7. Meanwhile, the universal remote controller 20 (20′) sends various information and commands to the internet-connected device 7. The corresponding relations between the universal remote controller 20 (20′) and the internet-connected device 7 may be one-to-one, one-to-many, many-to-one, or many-to-many, but not limited to this embodiment. In the previous embodiments, the universal remote controller 20 (20′) is in a bidirectional wireless communication with the second electronic device 40, so as to control the second electronic device 40 not to operate when the universal remote controller 20 (20′) fails. However, it should be known from the above that, the universal remote controller 20 (20′) and the second electronic device 40 may also implement the unidirectional wireless communication there-between as shown in this embodiment.

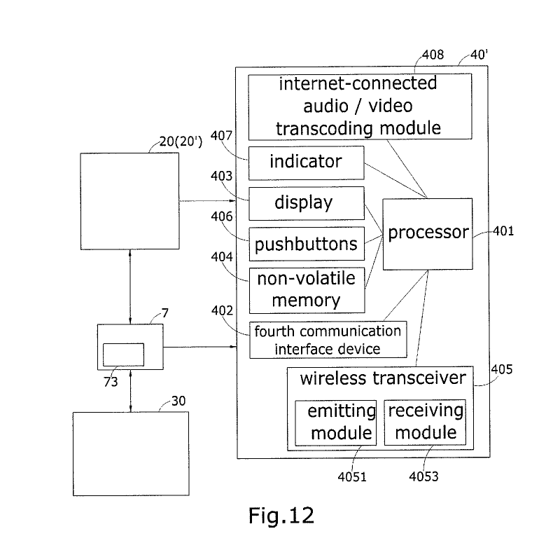

FIG. 12 is a schematic drawing illustrating an arrangement of a universal remote controller 20 (20′), a first electronic device 30, and a second electronic device 40′ according to a method of this invention. The first electronic device 30 may be a computer, a remote server, or a remote web site.

To compare the above-described embodiment with this embodiment, the second electronic device 40′ further includes an internet-connected Audio/Video Transcoding Module 408 connected to the processor 401, and the internet-connected device 7 is directly communicated with the second electronic device 40′.

In this embodiment, the universal remote controller 20 (20′) may be used to search for the first electronic device 30 at a specified location or a unspecified location, for example, search for the first electronic device 30 according to an IP location thereof. The first electronic device 30 may include a database (not shown), and the content of the database may include, but not limited to, the same or extensive information (such as life information, including but not limited to, weather information, stock information, auction information, and E-mail information), as well as the same or similar videos, texts, and patterns. Similarly, the first electronic device 30 may directly send the corresponding content to the universal remote controller 20 (20′) and/or the second electronic device 40′.

Particularly, the multimedia data (including but not limited to aspects such as music, videos, photos, and pictures) stored in the second electronic device 40′ may be actively or passively queried through the universal remote controller 20 (20′), and then, the universal remote controller 20 (20′) gives instructions (including but not limited to selection of a single or a plurality of files, immediate, timed, or scheduled playback, and deletion of a single or a plurality of files) to the internet-connected device 7, so that the internet-connected device 7 operates correspondingly. When the playback operation is instructed, the internet-connected device 7 directly sends the selected file (instead of sending through the universal remote controller 20 (20′)) to the second electronic device 40′ for playback. Certainly, the selected file may also be sent to a plurality of electronic devices for sharing, but the sending mode is not limited hereby. That is, the internet-connected device 7 can connect to the second electronic device 40′ or other electronic device(s).

In addition, the user may send an instruction to the internet-connected device 7 through the universal remote controller 20 (20′) by using only one finger, and then the internet-connected device 7 is connected to the internet to search for the information (including but not limited to videos, audios, images/graphs/pictures, and data) from websites of specific or unspecific IP addresses. Then, the internet-connected device 7 sends the obtained information to the universal remote controller 20 (20′), a single or a plurality of electronic devices (40, 40′, 41, 43, and 45) for displaying or playback, so as to realize the internet searching, displaying, and playback by using only one finger. In some embodiments, the obtained information may display by the internet-connected device 7 when the internet-connected device 7 includes but not limited to a display 73.

Furthermore, the present invention can also provide other signals and instructions. For example, the present invention can be used to make a reservation about the time for viewing a specific program. The time is input to the non-volatile memory 211 through the keypad 207′, the pushbuttons 207, or the pushbuttons 406, and tie sound generator 215 makes a sound to remind the user about the specific program at a certain time (for example, 15 minutes) before the program starts. Moreover, the present invention can be used to run a regional channel setting (channel setting) process. For example, the CATV service is operated by different companies in different cities, and different companies may number the channels differently. The user may input the company name of the city where he/she belongs to, and the third communication interface device 204 or the wireless transceiver 213 is connected to the first electronic device 30 to search for the channel setting data, so as to automatically obtain the corresponding channel information. The data (channel setting data) is gathered and integrated in the database of the first electronic device 30 such as a server.

Compared with Picture-in-Picture (PIP) played on a conventional TV, the technical solution of the present invention lies in the display 209 disposed on the remote controller itself, so as to relatively reduce the interferences caused by the PIP when watching the program, thereby reducing the conflicts there-between. Meanwhile, the present invention also provides a plurality of intelligent functions, for example, when many channels exist in a category, the non-volatile memory 211 records such information, and the processor 201 calculates and processes the information, such that the channels viewed frequently appear on the top of the list shown ill the display 209, and the channels less frequently viewed appear on the bottom part of the list. The channel priority order is automatically adjusted with the changing of the viewing habits, so as to realize the intelligent learning function Furthermore, the present invention can change an input mode. For example, the present invention has two interfaces, one is a display interface showing an operation status, and the other is a virtual operating interface. The operating interface may be a touch control interface, which includes a plurality of virtual keys. The names of the keys may be changed flexibly (for example, frequently used keys may appear on the interface), and the names of the keys may be shown according to the current status (for example, Japanese Series Channel may be changed to Japanese and Korean Series Channel). In addition, if the universal remote controller 20 (20′) is hidden by someone on purpose or it is missing by accident, the user can find out the universal remote controller 20 (20′) immediately through the following manners. For example, relevant conditions are preset in the non-volatile memory 211 of the universal remote controller 20 (20′), and when the universal remote controller 20 (20′) cannot be found (or it is not operated for a specific time period), the universal remote controller 20 (20′) automatically reminds the user about where it is (for example, through sounds generated by the sound generator 215 or other modes). Alternatively, the universal remote controller 20 (20′) is called at any time or immediately through the internet-connected device 7 (that is, PC or dongle) or the first electronic device 30, and when the universal remote controller 20 (20′) is called, the universal remote controller 20 (20′) automatically reminds the user about where it is (for example, through the sounds generated by the sound generator 215 or other modes). Thus, the Where Am I function is realized.

It should be noted that, the implementing aspects of the above embodiments are not limited to a single embodiment, but may be combined or partially replaced by one another, so as to provide different implementing methods and implementing flexibility. For example, the second electronic device 40′ of FIG. 12 may be replaced by the second electronic device 40 of FIG. 10, the second electronic device 40 of FIG. 11 may be replaced by the second electronic device 40 of FIG. 2, the keypad 207′ of FIG. 8a may be replaced by the pushbuttons 207 of FIG. 2 or the pushbuttons 406 of FIG. 8b, and the communication manner between the universal remote controller 20 (20′) and the second electronic device 40 (40′) of FIGS. 2, 9a, 9b, or 10 is not limited to the bidirectional wireless communication, but may be changed to the unidirectional wireless communication. Persons of ordinary skill in the art can understand such variations and implement accordingly, which thus will not be illustrated one by one by depicting corresponding drawings.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A method of controlling a remote-controlled electronic device using a universal remote controller with a first communication interface device and a second communication interface wirelessly connected thereto, comprising the steps of: providing a universal remote controller; establishing a bidirectional communication link between the universal remote controller and a first electronic device, wherein the communication link is established by the first communication interface device and first electronic device, such that the universal remote controller is able to obtain a playback list from the first electronic device through the bidirectional communication link and the first electronic device is able to obtain a user related information from the first electronic device through the bidirectional communication link, wherein the playback list includes at least one broadcasting entry; the universal remote controller classifying the playback list based on attributes of individual broadcasting entries; and the universal remote controller receiving execution commands from an input device based on the classified playback list, and the universal remote controller transmitting wireless signal commands corresponding to the execution commands to the second electronic device based on the execution commands, so as to update and display the playback and the user related information in real-time.

2. The method of controlling of claim 1, wherein the first electronic device is selected from one of a computer, a remote server and a remote web site.

3. The method of controlling of claim 1, wherein the bidirectional communication link is selected from one of a wired communication link, a wireless communication link, a WAN and a LAN.

4. The method of controlling of claim 1, wherein the wired communication link is a USB communication link.

5. The method of controlling of claim 1, wherein the playback list is selected from program broadcasting schedules provided by individual cable service providers, a Karaoke soundtrack summary table, a CD/MP3 soundtrack summary table, a DVD movie title summary table and a VCD movie title summary table, and the user related information is selected from user behavior patterns, evaluation, environment information, location information, and recommendation from user(s).

6. The method of controlling of claim 1, wherein the second electronic device is selected from a DVD/VCD/CD/MP3 player, a TV set, an audio appliance, a computer, a Karaoke player, a set-top-box, a multimedia device, an entertainment device, and a detection and control device.

7. The method of controlling of claim 1, wherein the input device includes at least one of plural pushbuttons, keypad, and a touch screen provided to the universal remote controller, and the keypad is a physical keypad or a virtual keypad.

8. The method of controlling of claim 1, wherein the first electronic device and the second electronic device are of a single electronic device.

9. A universal remote controller, comprising: a first communication interface device, for communicating with a first electronic device through a bidirectional communication link; a second communication interface device, for communicating with a second electronic device; at least one input device, for generating at least one signal; a display, for displaying a operation screen of the universal remote controller; a processor, electrically connected to the first communication interface device, the second communication interface device, the input device and the display, and served to: obtain a playback list from the first electronic device through the bidirectional communication link and the first electronic device is able to obtain a user related information from the first electronic device through the bidirectional communication link, wherein the playback list includes at least one broadcasting entry; classify the playback list based on attributes of individual broadcasting entries; and receive the signal, wherein the signal serves as a execution command of the classified playback list; and transmit wireless signal command corresponding to the signal to a second electronic device based on the signal, so as to update and display the playback and the user related information in real-time; a non-volatile memory, electrically connected to the processor and storing the classified playback list.

10. The universal remote controller of claim 9, wherein the first communication interface device is a USB communication interface device.

11. The universal remote controller of claim 9, wherein the first communication interface device is selected from one of a wired communication interface device and a wireless communication interface device.

12. The universal remote controller of claim 9, wherein the first electronic device is selected from one of a computer, a remote server and a remote web page, and the first electronic device is electrically connected to an internet-connected device.

13. The universal remote controller of claim 9, wherein the playback list, is selected from program broadcasting schedules provided by individual cable service providers, a Karaoke soundtrack summary table, a CD/MP3 soundtrack summary table, a DVD movie title summary table and a VCD movie title summary table, and the user related information is selected from user behavior patterns, evaluation, environment information, location information, and recommendation from user(s).

14. The universal remote controller of claim 9, wherein the second electronic device is selected from a DVD/VCD/CD/MP3 player, a TV set, an audio appliance, a computer, a Karaoke player, a set-top-box, a multimedia device, a entertainment Device, and a detection and control device.

15. The universal remote controller of claim 9, wherein the first electronic device and the second electronic device are of a single electronic device.

16. A method of controlling a remote-controlled electronic device using a universal remote controller wherein the universal remote controller is communicating with a first electronic device through a internet-connected device and is communicating with at least one second electronic device through a communication link, the method comprising the steps of:
establishing a bidirectional communication link between the universal remote controller and the first electronic device through the internet-connected device;
providing a first information to the first electronic device directly and/or providing a second information to the first electronic device from the universal remote controller through the internet-connected device; and
providing a using/enabling status of the first electronic device based on the first information and the second information, so that the universal remote controller generates an information corresponding to the using/enabling status so as to update and display the first information and the second information in real-time.

17. The method of controlling of claim 16, further comprising steps of setting relevant conditions on the universal remote controller, and sending the set conditions to the internet-connected device, wherein the internet-connected device is connected to the internet and operates on the network in compliance with the conditions, and the internet-connected device stores all records about operations on the internet for making a query, or directly sends the records back to the universal remote controller or the first electronic device.

18. The method of controlling of claim 16, further comprising a step of adjusting/selecting a traffic by the universal remote controller according to a traffic status returned by the internet-connected device, when the universal remote controller is connected to the first electronic device.

19. The method of controlling of claim 16, further comprising a step of upgrading the universal remote controller according to parameters or settings downloaded from first electronic device or variables of the universal remote controller itself.

20. The method of controlling of claim 16, further comprising a step of, when a program related to the second information is played, displaying a synchronous or asynchronous interactive message corresponding to or supplementary with the program on the universal remote controller.

21. The method of controlling of claim 16, further comprising a step of allowing a user to exit before operations of a certain function are completed and to directly execute a currently operable function according to different statuses of the internet-connected device in different time or different stages.

22. The method of controlling of claim 16, further comprising a step of searching for the first electronic device at a specific or unspecific location by the universal remote controller, so as to obtain a database storing a content, wherein the content corresponding to the first electronic device is directly sent to the universal remote controller and/or the second electronic device.

23. The method of controlling of claim 16, further comprising a step of connecting the universal remote controller to the internet through the internet-connected device, so as to perform an IP-based voice communication/call.

24. The method of controlling of claim 16, further comprising steps of setting relevant conditions on the universal remote controller, and automatically positioning the universal remote controller after the universal remote controller is missing or is not operated for a specific time period.

25. The method of controlling of claim 16, further comprising a step of calling the universal remote controller at any time or immediately through one of the internet-connected device and the first electronic device, so as to automatically position the universal remote controller.

26. The method of controlling of claim 16, further comprising a step of searching for channel setting data to automatically obtain a corresponding channel message.

27. The method of controlling of claim 16, wherein the internet-connected device is connected to the second electronic device.
